(19) United States
(12) Patent Application Publication
(10) Pub. No.: US 2025/0066069 A1
(43) Pub. Date: Feb. 27, 2025

(54) CONSUMER PRODUCTS AND METHODS FOR OPERATING THE SAME

(71) Applicant: The Procter & Gamble Company, Cincinnati, OH (US)

(72) Inventors: Guillaume Nicolas Louis BLOUET, Brussels (BE); Jan Dominiek VERBRUGGE, Oelegem (BE)

(21) Appl. No.: 18/810,955

(22) Filed: Aug. 21, 2024

(30) Foreign Application Priority Data
Aug. 23, 2023 (EP) 23192988.6

(51) Int. Cl. B65D 5/54; B65D 5/10; B65D 5/468

(52) U.S. Cl. CPC B65D 5/541; B65D 5/106; B65D 5/4608

(57) ABSTRACT

A consumer product (100) containing a container (102) and a detergent (104) product contained therein, the container comprising: a base (106); a first sidewall (108) and a second sidewall (110), the first and the second sidewalls (108, 110) having a respective top edge (109, 111), the detergent product (104) lying in direct contact with the plurality of sidewalls (108, 110); and a cover (116) comprising: a lower flap (118) connected to the top edge (109) of the first sidewall (108), the lower flap being provided with a tab receptor (122); and an upper flap (120) connected to the top edge (111) of the second sidewall (110), the upper flap containing a tab (124) repeatably engageable into, and repeatably releasable from, the tab receptor (122).

### BACKGROUND

This invention generally relates to containers for detergent products. Such containers containing detergent products are consumer products present in consumer homes, in particular in rooms such as a kitchen, a laundry room or a bathroom, which tend to generate a humid environment. It is important that the container be configured to adequately protect the detergent product from degradation due to an excessive exposure to such moisture or humidity.

### BRIEF DESCRIPTION OF THE DRAWINGS

FIGS. 1A-B illustrate an example consumer product.

FIG. 2A-B illustrate another example consumer product.

FIG. 3A-B illustrate another example consumer product.

FIG. 4 illustrates another example consumer product.

FIG. 5 illustrates another example consumer product.

FIG. 6 illustrates another example consumer product.

FIG. 7A-B illustrate another example consumer product.

FIG. 8A-C illustrate other example consumer products.

FIG. 9 illustrates another example consumer product.

FIG. 10A-B illustrate another consumer product.

FIG. 11A-C illustrate a first example method.

FIG. 12A-C illustrate a second example method.

FIG. 13A-B illustrate a third example method.

FIG. 14A-B illustrate a fourth example method.

FIG. 15A-B illustrate a fifth example method.

FIG. 16 illustrates a sixth example method.

### DETAILED DESCRIPTION

Detergent products are sensitive to humidity. They should be contained in specifically designed containers, and in particular containers which may be properly locked or closed before and after use, to prevent the detergent composition from being overly exposed to environmental humidity. At the same time, the container must be easy to operate for an adult consumer. The opening/closing mechanism should thereby reliably prevent accidental opening while offering a reliable unlocking/locking operation for an adult consumer. Additionally, the amount of material that is to be used for manufacturing a container should be as low as possible for environmental reasons while simultaneously shielding the detergent product from humidity.

In other words, the container of the present disclosure uses a reduced amount of material without compromising the protection against moisture ingress or the usability by the end user. Existing containers for detergent products are generally made of two pieces: a box and an insert. The insert overlaps an opening of the box and prevents the detergent product from falling over the box when the cover is being opened (the cover is initially attached to the box and the end user may enable the opening of the cover by pulling a tear strip located on a sidewall). By arranging the opening fully on the top side of the container, or in other words by not providing the sidewalls of the container with any feature related to the openable cover of the container, the risk for the detergent product to fall over the container does not exist. Thus, the container of the present disclosure can be designed without any insert. The design of the container of the present disclosure results in up to 10% less carton material in comparison with these existing containers of similar capacity, whilst providing for reduced moisture ingress and improved useability by the end user.

In the present disclosure, the detergent product is in direct contact with the container. In some examples, the detergent product is a powder or granular detergent. In some examples, the detergent product is constituted by unit doses made each of a water-soluble pouch enclosing a powder. If the detergent product is a powder, at least some powder particles contact the sidewalls, the base or the cover of the container. If the detergent product is a detergent unit dose, the water-soluble pouch enveloping the active product constitutes part of the detergent product, and at least some of the water-soluble pouches are in contact with the sidewalls, the base or the cover of the container. In other words, no intermediate body (film, insert, layer or material, etc.) separates the content of the container from the container.

Indeed, a further benefit of the present disclosure is that no further elements (film, insert, clip, tear strip) is required to properly conceal the detergent product. In particular, there is no need for a tear strip, these strips that are sometimes provided to allow the end user to divide two portions of a container, making it possible to open the container. Tear strips and other clips make the recycling of the container more cumbersome, and their absence is beneficial for the environment.

The opening/closing mechanism according to this disclosure comprises a tab cooperating with a tab receptor. The tab is repeatably (or reversibly) engageable into, and releasable from, the tab receptor. Repeatably (or reversibly) should be understood as the property of the container to offer several times access to the detergent product without the container being deteriorated. This constitute a difference from, for example, one-off mechanisms such as tamper proof mechanisms which would, due to their function, not be reversible. In some examples, the tab can be engaged into the tab receptor (or released therefrom) at least 10 times, or at least 50 times or at least 100 times. In some examples, the container is made of corrugated material comprising flutes extending in a longitudinal direction and the tab deforms perpendicularly to the main direction of the flutes. This may provide a memory effect for the deformation of the tab.

A consumer product should in this disclosure be understood as a product which is provided, among others, to end consumers. Such consumer products may for example be available for purchase in supermarkets and end consumers may store such consumer products in their homes. Consumer products may be provided in large quantities and environmental concerns should thereby be taken into consideration when designing the products. Consumer products should also be designed taking transportation to a retail store into account. Consumer products should also be robust so as to withstand transportation as part of an e-commerce shipment. Consumer products should also be designed taking on the shelf storage in a retail store into account. Consumer products should also be designed taking transportation from a retail store to a consumer home into account. Consumer products should also be designed taking storage at a private end-consumer home into account. Consumer products should also be designed taking use of the consumer product at a private end consumer home into account. Consumer products should also be designed taking disposal into account.

The consumer product according to this disclosure comprises a detergent product. Detergent products should be understood in this disclosure as products comprising a surfactant. Detergent products may also comprise a bleach or other ingredients. Example detergent product compositions are described in more detail herein below. In some examples, the detergent product comprises unit dose detergent pouches, preferably water-soluble unit dose detergent pouches, more preferably flexible water-soluble unit dose detergent pouches. Example unit dose detergent pouches are described in more detail herein below. One should note that in some cases, the containers according to this disclosure may also be suitable for content other than a detergent product, in particular for content of a perishable nature, such as food or unstable chemical substances for example.

The consumer product according to this disclosure further comprises a container. A container should be understood in this disclosure as an object housing a content, for example in a cavity of the container. The container facilitates protection, transport, storage, access and disposal of the consumer product.

In this disclosure, the container should be understood as comprising a generally parallelepiped, barrel shaped, cylindrical, round, oval or cubical three-dimensional box defining a cavity. The use of parallelepiped boxes may facilitate storage and transportation by making it possible to stack containers onto each other in a space-efficient manner. In some examples, a box may be a parallelepiped provided with some rounded, tapered trapezium or chamfered edges. The box according to this disclosure encloses the detergent product. It should be understood that the detergent product is contained or stored in the box directly, i.e., there is no intermediate layer or intermediate packaging separating the detergent product from the inner cavity of the box. When the detergent product is a detergent unit dose, the water-soluble pouch enveloping the active product constitutes part of the detergent product, i.e., there is no intermediate layer or intermediate packaging separating the box from the water-soluble pouch.

The container according to this disclosure comprises a base, sidewalls, the base and sidewalls corresponding to the box, and a cover. A base according to this disclosure should be understood as a wall on which the container may lie when placed on a supporting surface such as a shelf or a floor. The base may be made from a plurality of flaps folded with respect to the sidewalls such that those flaps forming the base lie in a substantially coplanar manner or in substantially parallel planes. In some examples, the base is flat. In some examples, the base is rectangular. In some examples, the base is oval or round. In some examples, the base has an embossed profile standing in or out in relief.

The sidewalls according to this disclosure should be understood as extending from the base and connecting the base to the cover. It should be understood that the connection of the base to the cover may include one or more transition pieces in addition to a sidewall. In some examples, a transition piece may be glued or otherwise attached to the sidewall. In some examples, the sidewalls are perpendicular to the base. In some examples, the base is rectangular and has four sides, four sidewalls extending perpendicular from the base, each sidewall being rectangular, each side wall being connected by a sidewall side to a side of the base, and by two other sidewall sides to two other of the four sidewalls. In some examples, the base is oval or circular and the sidewalls form a generally cylindrical wall extending from the base in a direction normal or perpendicular to the base. In some examples, sidewalls have a shape corresponding to one of a square, a rectangle, a trapeze, a polygon, a section of a sphere, a section of an ovoid, or a section of an ellipsoid. The sidewalls and the base may form an inner cavity where the detergent product is received.

The sidewalls of the present disclosure have a respective top edge. The top edge should be understood as an edge delimiting an end of each sidewall, which end is at the top of the sidewall, as the container is arranged in a regular position with its base at the bottom.

The cavity occupied by the detergent product is covered by a cover which may be open to enable access to the product by a consumer and which may be closed to prevent access to the cavity. The cover according to this disclosure should be understood as an element permitting to repeatedly close or open the container. The cover according to this disclosure is arranged at a top position of the container, i.e., opposite the base.

The cover is intended to lie at the top of the container and the base is intended to lie at the bottom of the container. However, during the filling process of the container, and/or during shipment, and/or during storage, the container may be positioned upside down, i.e., the base being on top of the container and the cover being at the bottom. The container may also be positioned sideways, i.e., with one of the sidewalls being on top and/or one of the sidewalls being at the bottom.

The container and in particular the cover of the container may comprise flaps. In the present disclosure, when referring to the container, a flap is a portion of the container that is hinged to another portion of the container at a folding line. In some examples, the container is made of corrugated material comprising flutes extending in a longitudinal direction and the folding lines of the flaps are perpendicular to the main direction of the flutes. This may provide a memory effect for the folding operations of the flaps. The relative movement of the flap with respect to other portions may be partially or totally prevented by other flaps or by attachment of the flap to other portions of the container. When referring to a container blank which may be used to form the container of the present disclosure, a flap is intended to depict a portion of the blank that is connected to exactly one other portion of the blank by a crease line.

In particular, the cover comprises at least a lower flap and an upper flap, connected to respective top edges of respective sidewalls. In a closed configuration, the upper flap is folded over the lower flap. In an example, both the upper and lower flaps cover substantially the entirety of the cavity formed by the base and the sidewalls. The upper flap of the present disclosure comprises a tab and the lower flap comprises a tab receptor receiving the tab reversibly. The tab may be formed integrally with the upper flap. The tab receptor may be formed integrally with the lower flap.

As will be explained further below, the ability for the tab to engage the tab receptor, or the ability for the tab receptor to receive the tab may require an initial procedure which may consist in releasing the container from an initial configuration.

A tab should be understood as a portion of the container that protrudes from a larger portion of the container. A tab receptor should be understood as any device of any construction which can receive and maintain the tab, for instance by mechanical fitting or entrapment. The tab receptor may be a recess, a slit, a multilayer arrangement, etc.

The tab of the upper flap may protrude in a through-opening of the upper flap. A through-opening is to be understood as a recess extending through the entirety of the thickness of the upper flap and surrounded by a closed contour of material of the upper flap (in contrast to a notch which would be only partially surrounded by material).

It should be understood that the tab/tab receptor closing mechanism according to this disclosure is expected to function under normal condition of use of the container. It should be understood that the closing mechanism may not fulfill its function when for example unusual use is made of the container, or when the container is used under unusual conditions.

In some examples, the container comprises various precut lines arranged in one or more flaps. These precut lines can be lines of weakness (in comparison to the strength of material in their vicinity) intended to rupture when a sufficient shearing force is applied to the container. Precut lines can consist in a linear or a curved segment of a flap (or a panel) and can be formed by partially cutting the material. The partial cut may be in the thickness direction, i.e., a portion of the thickness of the flap/panel has been cut. The local thickness of the material is thus smaller at the precut line than around the precut line. Alternatively, the precut line can be formed by a dashed line of through-cuts, cutting intermittently through the entirety of the thickness of the flap/panel. A precut line may also comprise a combination of one or more partial cuts in the thickness direction and of one or more interrupted line of through cuts. Other techniques may be used to weaken the flap/panel in a precut line.

In some examples, precut lines of the container are teared off when the end user opens the container for the first time, disjointing regions of those flaps which are initially subdivided by the precut lines.

The container may then also comprise teared-off edges resulting from having teared off the precut lines. Hence, if a flap or a panel initially contains a precut line, by operating the container, the end user may generate two mirroring teared-off edges, potentially separating the flap into two distinct bodies, each of which having a respective teared-off edge.

In some examples, the precut lines separate a proximal region of a flap from a distal region of a flap. Proximal regions are to be understood as a portion of the flap nearby or including a proximal edge, i.e., an edge of the flap that connects the flap to another portion of the container. Proximal edges are the axis of rotation of the pivoting movement of the flap, in use. Distal regions of a flap are to be understood as a portion of the flap remote from the proximal edge. Distal regions may comprise a distal edge of the flap, i.e., an edge that is the most remote from the proximal edge. In some examples, the distal edge may be a free edge of the flap, not attached to any portion of the container.

In some examples, the container of the present disclosure is made from a container blank. The container blank can be made from one of the material or layered materials discussed hereby. A container blank (or die cut) is a substantially flat object that is specifically designed to be fed to a machine that can perform various operations, such as folding, gluing or the like, such as to obtain a container. A blank may be made of one piece of the above-mentioned material or may comprise several pieces attached together. When made from one single piece, the protection against moisture may be better. A blank has a thickness that is substantially smaller than its overall width or length.

The thickness may be homogeneous through-out the entirety of the blank or the thickness may vary. The blank may be constituted of one or more panels and one or more flaps, separated from each other by crease lines. Crease lines should be understood as linear segments of the blank which have endured a creasing process, so as to offer well-defined folding lines, which facilitate the folding operation and provide the conditions for the container to obtain its intended shape and function.

### DETAILED DESCRIPTION OF THE FIGURES

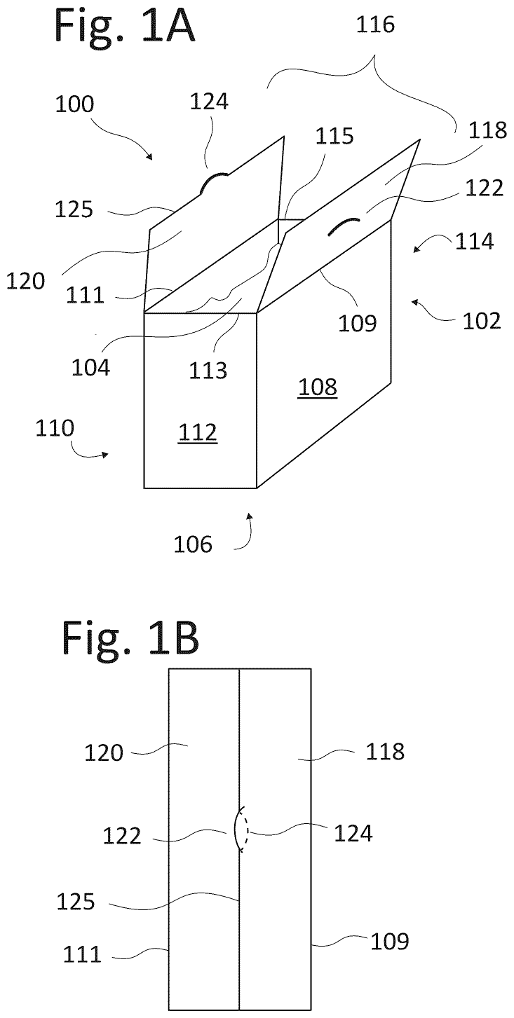

FIGS. 1A-1B illustrate an example consumer product 100 according to this description. The consumer product 100 is open in FIG. 1A. FIG. 1B is a top view of the closed consumer product 100. The consumer product 100 comprises a container 102 and a detergent product 104 therein enclosed. Examples of the composition of the detergent product are given below. Examples of the material used to make the container 102 are given below.

The container 102 comprises a base 106 (not directly visible on FIG. 1A), sidewalls 108, 110, 112, 114 and a cover 116. In some of the examples of the present disclosure, the container may have a general size as follows (when facing the sidewall 108): a depth comprised between 5 cm and 25 cm, preferably between 6.2 cm and 14.5 cm; a width comprised between 15 cm and 60 cm, preferably between 18.5 cm and 28.4 cm; and a height comprised between 15 cm and 70 cm, preferably between 20.5 cm and 50 cm. In some examples, the dimensions respect a shape factor that may be convenient for handling the container, storing the container, opening or closing the container, such as a width that is less than three times the depth of the container.

In this example, the container 102 is represented as a parallelepiped box, with four sidewalls extending substantially perpendicularly to the base. The skilled person would note that other designs are possible within the ambits of the present disclosure. In the illustrated example, a first sidewall 108 is arranged opposite a second (not visible) sidewall 110, and a third sidewall 112 is arranged opposite a fourth (not visible) sidewall 114. The sidewalls have respective top edges 109, 111, 113, 115. As already noted above, “top edge” is intended to designate an edge of the sidewalls that is positioned at the top of the sidewall when the container is positioned in a normal position of use, i.e., with the base 106 supporting the container and being positioned at the bottom of the container, while the cover 116 is at the top. The cover 116 is intended to be manipulated, for instance by the hand(s) of an adult end user, to allow or prevent access to the detergent product 104.

The cover 116 comprises a lower flap 118 connected to the first sidewall 108 at its top edge 109 and an upper flap 120 connected to the second sidewall 110 at its top edge 111.

In some of the examples discussed in the present disclosure, the lower flap and/or the upper flap may cover, each, at least 50% of the footprint of the cavity occupied by the detergent product, or at least 60%, or at least 70% or at least 80% or at least 90%.

The lower flap 118 comprises a tab receptor 122 and the upper flap 120 comprises a tab 124 reversibly engageable in the tab receptor 122. In this example, the tab 124 protrudes from a distal edge 125 of the upper flap 120. Other examples are shown in the following figures. The tab receptor 122 may take any suitable form that enables to receive the tab 124: the tab receptor 122 may be a slit formed in the lower flap 118. It may alternatively be a housing formed between a multi-layer portion of the lower flap 118 and configured to receive the tab 124. In yet another example, the tab receptor 122 may be a notch in a distal edge of the lower flap 118.

FIG. 1B shows a top view of the consumer product 100, the cover 116 being closed. One can see here that the tab 124 is at least partially hidden within the tab receptor 124.

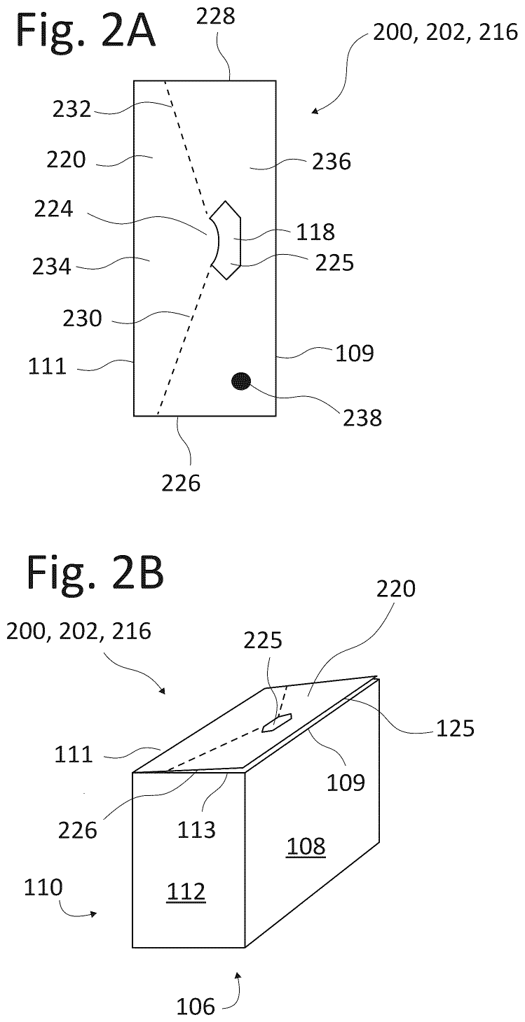

FIGS. 2A and 2B show an example of a consumer product 200. The same numbers as those used in the previous figures depict the same features of the consumer product. The consumer product 200 comprises a container 202 enclosing a detergent product (not visible). FIG. 2A is a top view of the (closed) container 202 and FIG. 2B is an isometric view of the same container 202.

In this example, a cover 216 comprises an upper flap 220 including a through-opening 225, i.e., a recess formed through the entire thickness of the upper flap 220. One can see the lower flap 118 when looking down at the through-opening 225. The through-opening 225 may have a contour line that may be substantially polygonal, such as a square, a rectangle, an elongated hexagon, etc. The apices of the polygonal shape may be rounded. The through-opening 225 is of a size that is sufficient for an end user to slide a finger in, for example 2 cm wide or more. The through-opening 225 may be positioned in any region of the upper flap 220. In a preferred embodiment, the through-opening 225 is closer to the top edge 109 of the first sidewall 108 than to the top edge 111 of the second sidewall 110. The through-opening 225 may have a geometric surface area (when seen from the top as in FIG. 2A) that may be comprised between 5% and 10% of the entire surface area of the upper flap 220.

The tab 224 of the upper flap 220 protrudes at the through opening 225. The upper flap 220 has two lateral edges 226, 228. These lateral edges 226, 228 may be adjacent to the top edges 113, 115 of the sidewalls 112, 114 (see FIG. 1A or 2B). Precut lines 230, 232 respectively connect the tab 224 to the lateral edges 226, 228. The precut lines 230, 232 and the tab 224 divide the upper flap 220 into two portions, a proximal region 234 and a distal region 236. The proximal region 234 is the portion of the upper flap 220 on the side of the top edge 111, where the upper flap 220 connects to the second sidewall (110 on FIG. 1A). The tab 224 belongs to the proximal region 234. The distal region 236 is a portion of the upper flap 220 away from its connection to the second sidewall 110. The distal region 236 is attached to the lower flap 118 by means of attaching element 238 which can be at least one of: glue, staple, adhesive tape, clips, etc. The attaching element 238 can be arranged at a specific location of the lower flap 118 or may be spread over a substantial portion of the interface between the distal region 236 and the lower flap 118. As will be apparent in conjunction with the figures below, when the user pulls the tab 224, the precut lines 230, 232 are teared off and the proximal region 234 is separated from the distal region 236. The proximal region 234 is thus articulated with respect to the second sidewall 110 while the distal region 236 remains attached to the lower flap 118, i.e., articulated with respect to the first sidewall 108. With the exception of the optional handle that is discussed below, the proximal region 234 is unattached, or becomes unattached to the lower flap, the proximal region 234 being substantially free of attaching element.

The precut lines 230, 232 of the upper flap 220 may have any shape. They can be linear (as shown) or may be curved. They may have any shape that facilitates the separation of the proximal region 234 from the distal region 236 when pulling the tab 224. When the precut lines 230, 232 are linear, they may form an angle α with the respective lateral edges 226, 228 that may be comprised between 45° and 80°, preferably between 70° and 80°.

The precut lines 230, 232 may be symmetrically arranged with respect to a middle line (horizontal middle line in the view of FIG. 2A).

The tab receptor (122 on FIG. 1A) is not visible on FIG. 2A as it is hidden by the upper flap 220. It is only once the tab 224 has been pulled and the precut lines 230, 232 are teared off, that the tab 224 becomes reversibly engageable with the tab receptor.

For the sake of clarity, FIG. 2B illustrates the same container as in FIG. 2A but in an isometric view, where one can see the sidewalls 108, 112 and the top edges 109, 113.

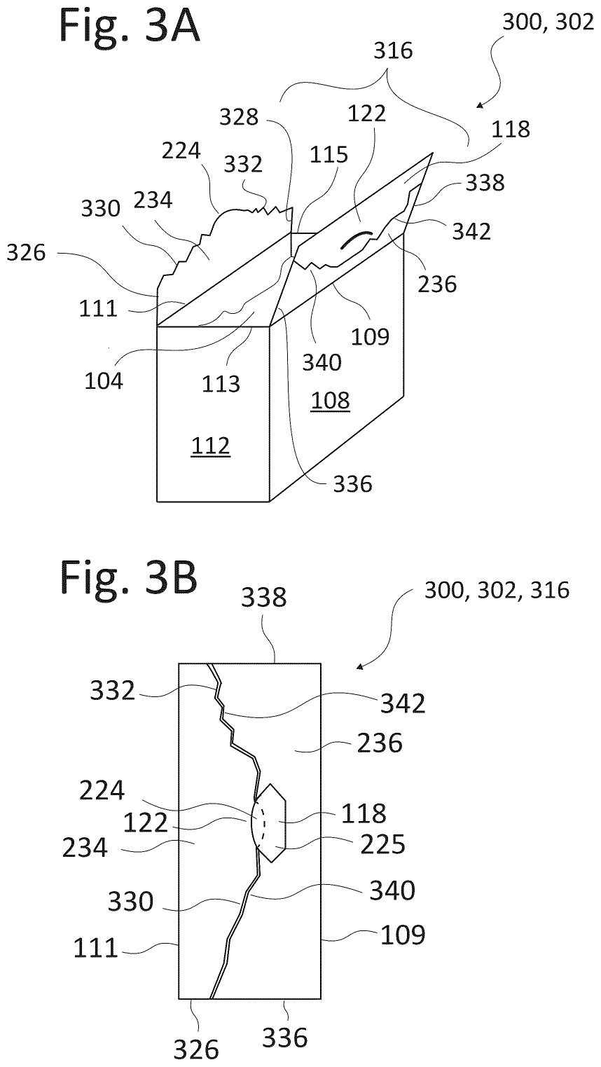

FIGS. 3A-3B show another example of a consumer product 300. The same numbers as those used in the previous figures depict the same features of the consumer product. The consumer product 300 comprises a container 302 enclosing a detergent product 104. FIG. 3A is an isometric view of the container 302 and FIG. 3B is a top view of the (closed) container 302.

The cover 316 comprises a proximal region 234 of an upper flap connected at the top edge 111 of the second sidewall 110 (not visible) and a distal region 236 adhering to the lower flap 118. The proximal region 234 bears the tab 224 and has two teared-off edges 330, 332 extending from the tab 224 to two lateral edges 326, 328 of the proximal region 234. The distal region 236 has two teared-off edges 340, 342 connecting two lateral edges 336, 338 of the distal region 236 to a recess 325. The teared-off edges 330, 332 of the proximal region 234 mirror the teared-off edges 340, 342 of the distal region 236. In one example, the teared-off edges 330, 332, 340, 342 result from tearing off the precut lines 230, 232 shown on FIG. 2A.

While FIG. 3A shows the container 302 in an open configuration, FIG. 3B shows a top view of the closed container 302. The tab 224 is here engaged in the tab receptor 122. One can see that the teared-off edges 330, 332, 340, 342 are forming pairs of mirroring edges.

It should be noted that in the accompanying figures, the shape of the teared-off edges is schematically shown as having a random profile for the reader to distinguish between the in-factory clean-cut edges of the container and the teared-off edges.

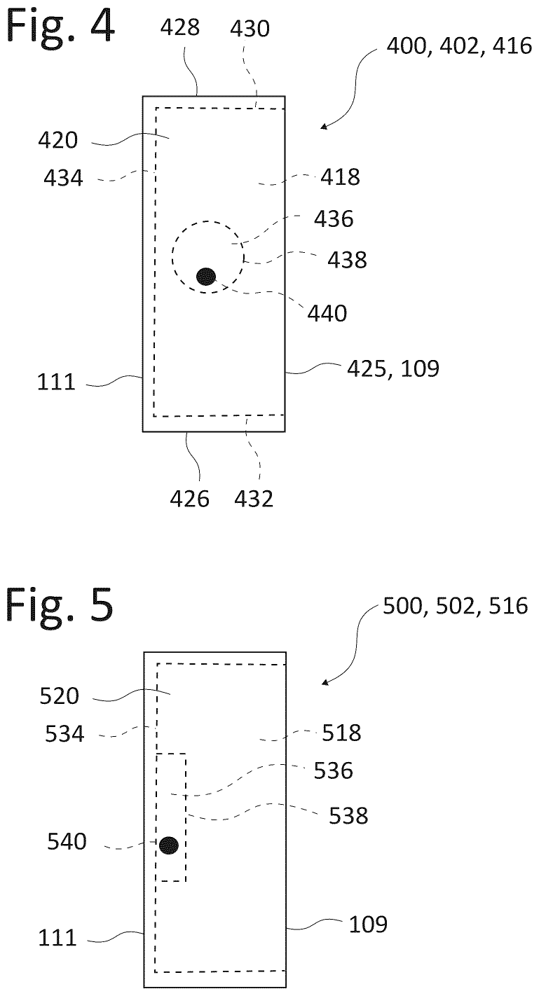

FIG. 4 shows an example of a consumer product 400. The same numbers as those used in the previous figures depict the same features of the consumer product. The consumer product 400 comprises a container 402 enclosing a detergent product (not visible). FIG. 4 is a top view of the (closed) container 402.

FIG. 4 shows a cover 416 where an upper flap 420 covers the entirety of the lower flap 418. The upper flap 420 and/or the lower flap 418 may be in accordance with any of the preceding figures. The tab and tab receptor are not represented for clarity reasons. In alternative examples, the upper flap 420 does not cover the entirety of the lower flap 418. The upper flap 420 has lateral edges 426, 428, as well as a distal edge 425 lying substantially above the top edge 109 of the first sidewall 108. Dashed lines show features of the lower flap 418 hidden below the upper flap 420: the lower flap 418 has two lateral edges 430, 432 and a distal edge 434 which may be adjacent the top edge 111 of the second sidewall 110. In an alternative embodiment, the lateral edges 426, 428 of the upper flap 420, and/or the distal edge 425 of the upper flap 420 are at such positions that portions of the lower flap 418 are visible from the top view shown on FIG. 4.

A handle region 436 of the lower flap 418 may be delimited by a handle precut line 438 and may be attached to the upper flap 420 by means of an attaching element 440. The attaching element may be at least one of: glue, staple, adhesive tape, clips, etc. The attaching element 440 can be arranged at a specific location of the lower flap 118 or may be spread over a substantial portion of the interface between the upper flap 420 and the lower flap 418 within the boundaries of the precut line 438. As will be apparent below, when the upper flap 420 is open for the first time, the handle region 436 is separated from the remaining of the lower flap 418 and remains attached below the upper flap 420, thereby forming a recess (a cutout handle) in the lower flap 418. Upon closing the container, the handle region 436 is replaced back in the recess, thereby scaling the container. When opening the container, the end user may first open the upper flap 420 and then open the lower flap 418 by introducing a finger in the recess (cutout handle) formed by the separation of the handle region 436 from the lower flap 418.

FIG. 5 shows an alternative or complementary example to the one shown on FIG. 4, i.e., a top view of a closed consumer product. The upper flap 520 and/or the lower flap 518 may be in accordance with any of the preceding figures. The tab and tab receptor are not represented for clarity reasons. Here, the consumer product 500 comprises a container 502 with a cover 516, an upper flap 520 and a handle region 536 that is delimited by a handle precut line 538 and by the distal edge 534 of the lower flap 518. The handle region 536 is attached to the upper flap 520 by attaching elements 540 which may be similar to the previously indicated attaching elements. Hence, by the same process as discussed above in relation to FIG. 4, opening the upper flap 520 results in forming a cutout handle in the lower flap. Here the cutout handle is positioned at the distal edge 534 of the lower flap 518. The cutout handle of FIG. 4 or FIG. 5 may have any size or shape sufficient for the introduction of at least one finger of an adult end user.

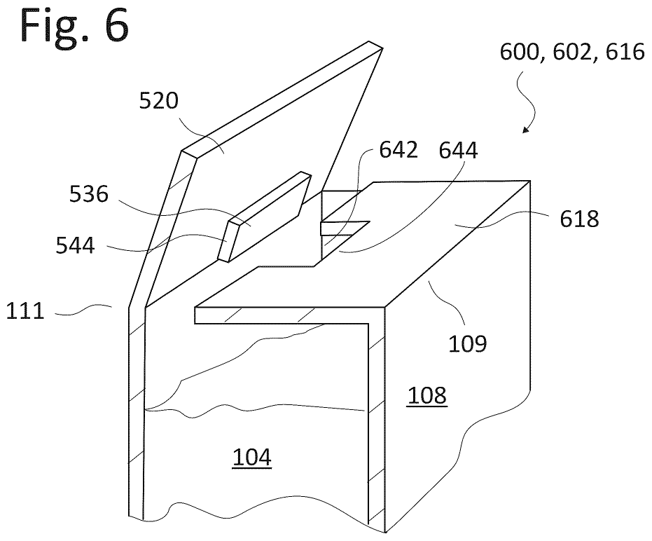

FIG. 6 shows an isometric view of a consumer product 600. The same numbers as those used in the previous figures depict the same features of the consumer product. The consumer product 600 comprises a container 602 enclosing a detergent product 104. FIG. 6 is a cross-section isometric view of the (open) consumer product 600.

One can see on FIG. 6 that the cover 616 of consumer product 600 has an upper flap 520 bearing the handle portion 536 attached thereunder, and that a cutout handle 642 is formed in the lower flap 618. The upper flap 520 and/or the lower flap 618 may be in accordance with any of the preceding figures. The cutout handle 642 has a shape that is complementary to the shape of the handle portion 536. The handle portion 536 is delimited by a teared-off edge 544 which mirrors a teared-off edge 644 of the cutout handle 642.

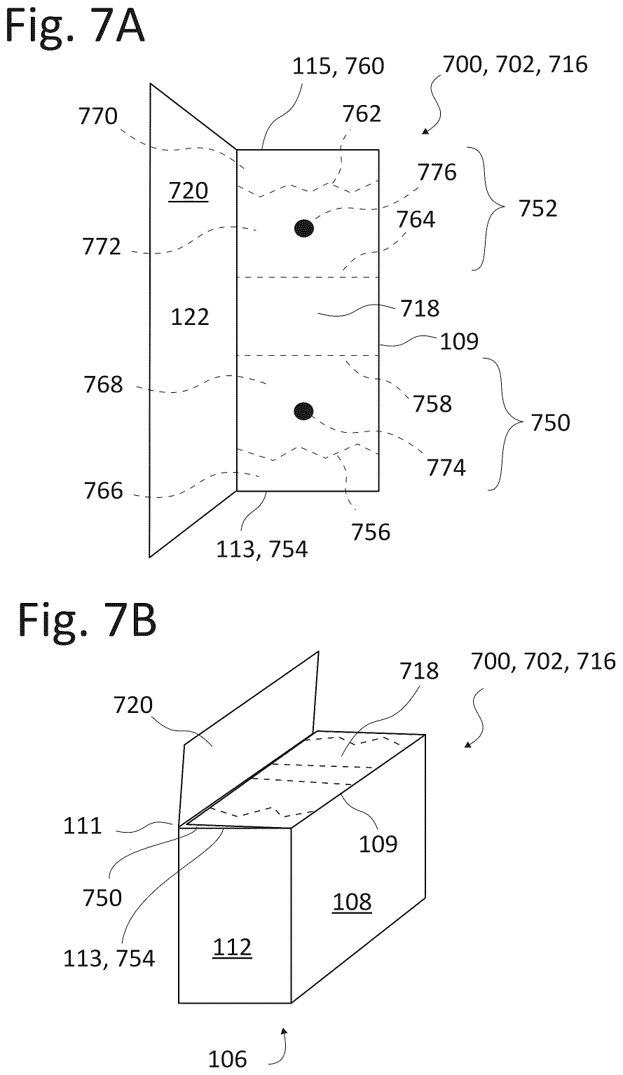

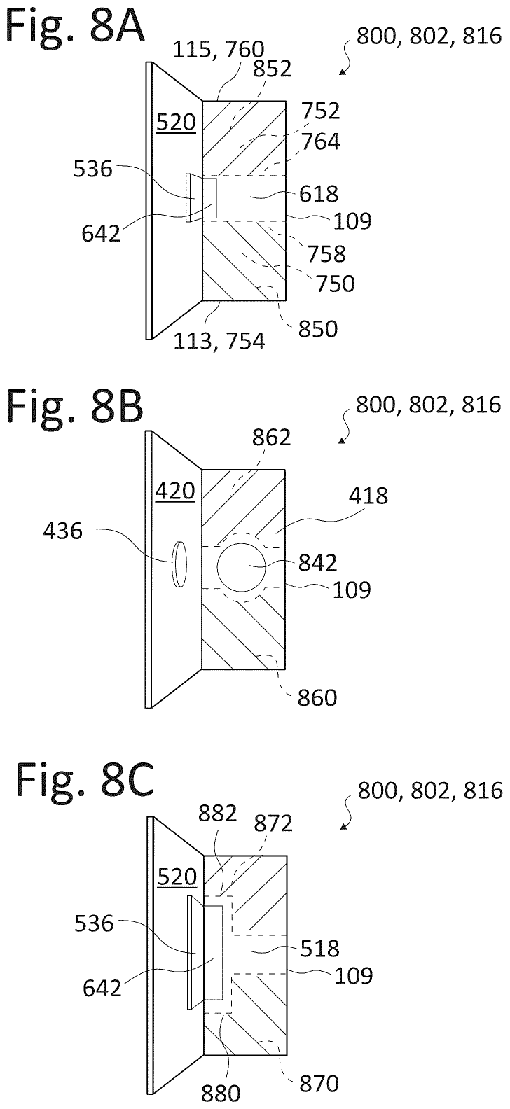

FIG. 7 shows an example of a consumer product 700. The same numbers as those used in the previous figures depict the same features of the consumer product. The consumer product 700 comprises a container 702 enclosing a detergent product (not visible). FIG. 7A is a top view of the (partially open) container 702. FIG. 7B is an isometric view of the example product 700.

On FIG. 7A, the cover 716 shows an upper flap 720 open and one can see a lower flap 718. The upper flap 720 and/or the lower flap 718 may be in accordance with any of the preceding figures.

Two secondary flaps 750, 752 are arranged below the lower flap 718. Each secondary flap 750, 752 extends from a respective top edge 113, 115 of the third and fourth sidewalls 112, 114. In one example, a single secondary flap is present. In one example, more than two secondary flaps are arranged, at least two of them extending from one of the top edges 113, 115.

The secondary flaps 750, 752 have a respective proximal edge 754, 760 which coincides with the top edges 113, 115. The secondary flaps 750, 752 have a respective secondary precut line 756, 762 and have a respective distal edge 758, 764, remote from the proximal edges 754, 760.

The secondary precut lines 756, 762 extend along the entire width of the secondary flaps 750, such that they divide the secondary flaps 750, 752 into two regions, a proximal region 766, 770 and a distal region 768, 772. The secondary precut lines 756, 762 may have an appropriate profile, for instance substantially parallel to the proximal edges 754, 760.

The distal regions 768, 772 are attached to the lower flap 718 by attaching elements 774, 776 which can be at least one of: glue, staple, adhesive tape, clips, etc. The attaching elements 774, 776 can be arranged at a specific location of the secondary flaps or may be spread over a substantial portion of the distal region 768, 772. The proximal regions 766, 770 are unattached, or become unattached to the lower flap, the proximal regions 766, 770 being substantially free of attaching element.

For the sake of clarity, FIG. 7B illustrates the same container as in FIG. 7A but in an isometric view, where one can see the sidewalls 108, 112 and the top edges 109, 113.

FIGS. 8A-8C show further examples of a consumer product 800. The same numbers as those used in the previous figures depict the same features of the consumer product. The consumer product 800 comprises a container 802 enclosing a detergent product (not visible). FIGS. 8A-8C are top views of the container 802 with a cover 816 that is partially open.

FIG. 8A shows a container 802 with the upper flap 520 in an open position. As in FIG. 6, a handle portion 536 is attached below the upper flap 520 and a cutout handle 642 is formed in the lower flap 618. The secondary flaps 750, 752 are hidden below the lower flap 618. The secondary flaps 750, 752 extend over a respective area of the lower flap, noted 850, 852. Seen from above, the areas 850, 852 do not overlap the cutout handle 642 and do not overlap the handle region 536 (when the upper flap 520 is folded down in a closed configuration). This absence of overlap enables the end user to freely insert a hand, a finger or fingers in the cutout handle 642 without interference of the secondary flaps 750, 752.

FIG. 8B shows an alternative or complementary example, where the cutout handle 842 is arranged in the middle of the lower flap 418. The areas 860, 862 occupied by the secondary flaps may be delimited by a distal edge having a notch or a recess around the cutout handle 842.

FIG. 8C shows yet another example, where the secondary flaps have a respective notch 880, 882 so that the areas 870, 872 occupied by the secondary flaps do not interfere with the cutout handle 642.

The distal edges 758, 764 of the secondary flaps may be as close as possible to the cutout handle 642, 842 (or to the handle precut lines 438, 538 in the initial configuration of the container), so that a proper sealing of the container is achievable in use.

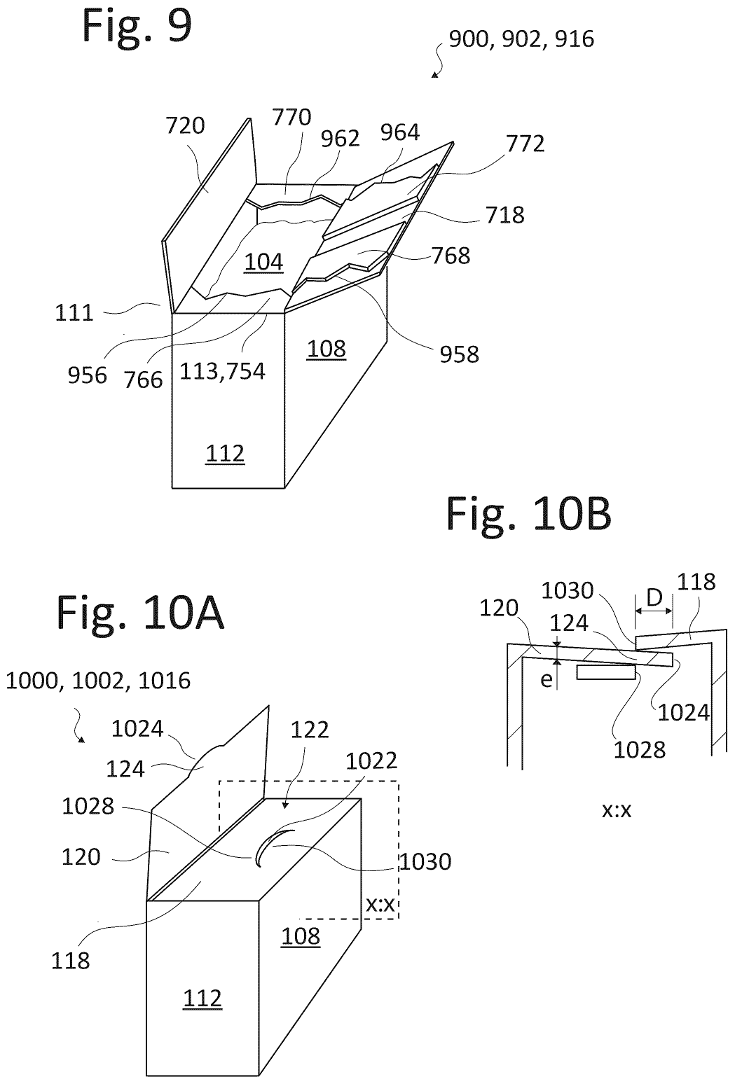

FIG. 9 shows a further example of a consumer product 900. The same numbers as those used in the previous figures depict the same features of the consumer product. The consumer product 900 comprises a container 902 enclosing a detergent product 104. FIG. 9 is an isometric view of the container 902 with an open cover 916.

The container 902 may correspond to the container 702 of FIG. 7 or to the container 802 of FIG. 8, after an end user has pulled the lower flap 718 open.

The container 902 comprises an upper flap 720 which may correspond to any of the aforementioned upper flaps. The lower flap 718 has distal regions 768, 772 attached thereunder, while proximal regions 766, 770 of the secondary flaps remain connected to the sidewalls 112, 114. Proximal regions 766, 770 have a respective teared-off edge 956, 962 and distal regions 768, 772 have a respective teared-off edge 958, 964 which mirror the teared-off edges 956, 962 of the proximal regions 766, 770.

In a closed configuration, the distal regions 768, 772 are adjacent to the proximal regions 766, 770 so that the top of the container is sealed. In an open configuration, the fact that the distal regions 768, 772 adhere to the lower flap 718 enables the end user to have an easier access to the detergent product 104.

FIGS. 10A-10B show examples of a consumer product 1000. The same numbers as those used in the previous figures depict the same features of the consumer product. The consumer product 1000 comprises a container 1002 enclosing a detergent product (not visible). FIG. 10A is an isometric view of the container 1002 with a cover 1016 that is partially open. FIG. 10B is a cross-section of the container 1002 when closed.

In this example, the tab 124 has a convex edge 1024 and the tab receptor 122 comprises a slit 1022 formed in the lower flap 118. The slit 1022 is a recess that is extending through the entirety of the thickness of the lower flap 118. The slit 1022 may be curved and may define a concave edge 1028 and a convex edge 1030. The convex edge 1030 may be closer to the top edge 109 of the first sidewall than the concave edge 1028. The slit 1022 may be substantially tangent to the tab 124, i.e., the convex edge 1030 may be slightly offset to a tangent of the convex edge 1024. The offset may be comprised between 0.5 and 10 mm, preferably between 2 mm and 8 mm, more preferably between 3 mm and 6 mm. This offset is labelled as D on FIG. 10B. FIG. 10B is a cross-section in the middle plane x: x as identified on FIG. 10A. In one example, D is comprised between 30% and 350% of the thickness e of the flaps 118, 120.

FIG. 10B also shows that the concave edge 1028 is below the tab 124 and that the convex edge 1030 is above the tab 124 as the tab 124 is engaged in the slit 1022.

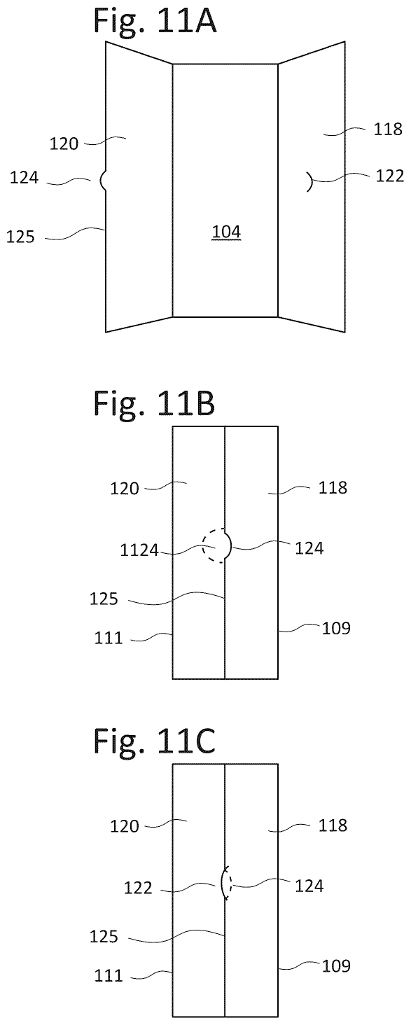

FIGS. 11A-11C illustrate a first example method in accordance with the present disclosure. The method can be carried out with a container according to any of the previous examples/figures. The method comprises a step of closing the container. Depending on the initial configuration of the container, e.g., if it is fully open as on FIG. 11A, one should first fold the lower flap 118 down, then fold the upper flap 120 down onto the lower flap 118 as on FIG. 11B. The core of the method lies with the engagement of the tab 124 into the tab receptor 122. This may be done by pressing down the upper flap 120. Preferably, pressing down the flap 120 by applying a downward force in a region 1124 in the vicinity of the tab 124 can facilitate the engagement of the tab 124 into the receptor 122. The region 1124 for applying the force may be a rectangle or an ellipse and/or may be limited to an area within 50 mm from the distal edge of the tab 124. The region 1124 can be identified with appropriate indications drawn on the container for informing the end user of where the most appropriate location is to press down the flap.

Once a sufficient pressing force has been applied to the upper flap 120, preferably in the vicinity of the tab 124, the tab 124 is engaged into the tab receptor 122 as shown in FIG. 11C. Haptic feedback can be produced by the engagement of the tab, such as a clicking sound and/or a sensible reduction in the force opposing the hand pressing down the upper flap.

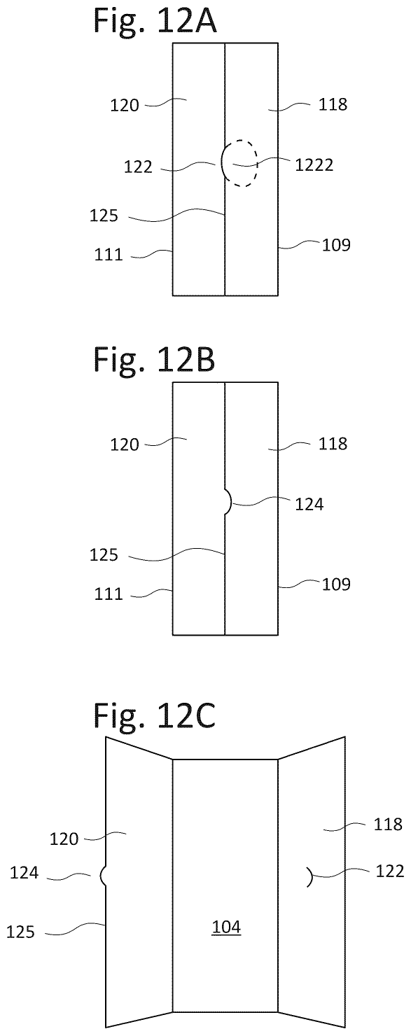

FIGS. 12A-12C show a second example method to be used with a container according to any of the previous examples/figures.

FIG. 12A shows a container in a closed configuration. The method can be carried out with a container according to any of the previous examples/figures. The method comprises a step of opening the container. Opening the container may be done by releasing the tab 124 from the tab receptor 122. This may be done by pressing down the lower flap 118. Preferably, pressing down the flap 118 by applying a downward force in a region 1222 in the vicinity of the tab receptor 122 can facilitate the disengagement of the tab 124 from the receptor 122. The region 1222 for applying the force may be a rectangle or an ellipse and/or may be limited to an area within 50 mm from the tab receptor 122. The region 1222 can be identified with appropriate indications drawn on the container for informing the end user of where the most appropriate location is to press down the lower flap.

Haptic feedback can be produced by the disengagement of the tab from the tab receptor, such as a clicking sound and/or a sensible reduction in the force opposing the hand pressing down the lower flap.

FIG. 12B shows the cover of the container after the tab 124 has been released from the tab receptor. The tab receptor is hidden below the upper flap 120.

FIG. 12C shows the cover wide open, once both upper and lower flaps 118, 120 are folded open.

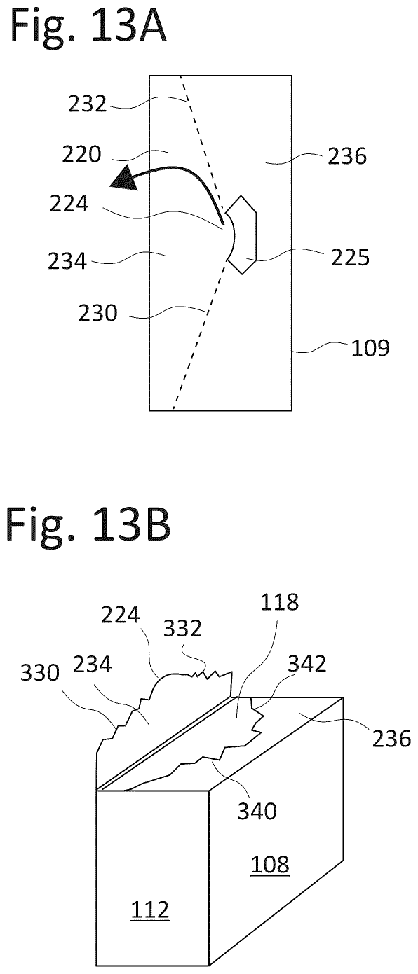

FIGS. 13A-13B show a third example method which can be carried with the container 202 or 302 and possibly in combination with any of the previously described examples/figures. FIG. 13A shows a closed container 202 before it has been opened for the first time. The core of the third method consists in pulling the tab 224 and simultaneously separate the proximal region 234 from the distal region 236. This may be rendered possible by tearing-off the precut lines 230, 232 to obtain teared-off edges 330, 332, 340, 342 as shown on FIG. 13B.

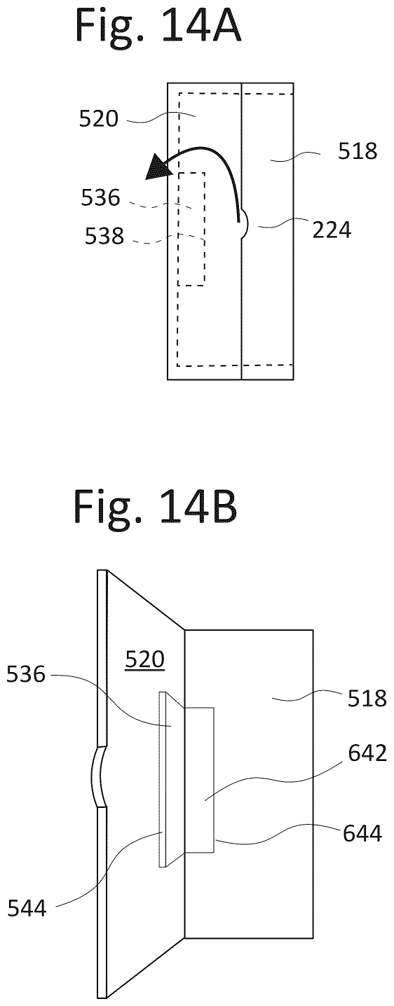

FIGS. 14A-14B show a fourth example method which can be carried with the container 502 and possibly in combination with any of the previously described examples/figures. FIG. 14A shows a closed container 502 before it has been opened for the first time. The core of the fourth method consists in pulling the tab 224 and simultaneously separate the handle region 536 from the lower flap 518, thereby forming the cutout handle 642. This may be rendered possible by tearing-off the precut line 538 to obtain teared-off edges 544, 644 as shown on FIG. 14B.

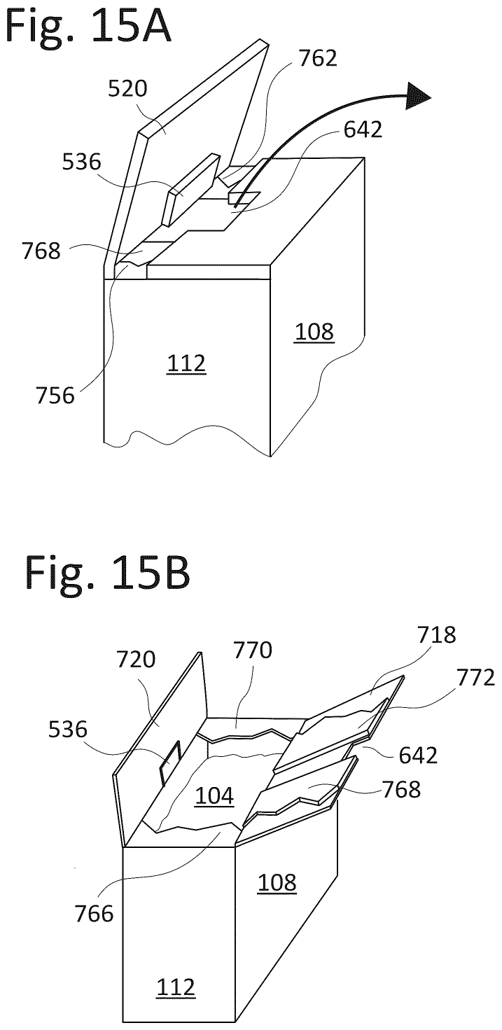

FIGS. 15A-15B show a fifth example method which can be carried with the container 702 and possibly in combination with any of the previously described examples/figures. FIG. 15A shows a partially closed container 702 before it has been fully opened for the first time. The core of the fifth method consists in pulling the lower flap 718 by optionally pulling the cutout handle 642 of the lower flap 718 and simultaneously separate the distal region(s) 762, 768 of the secondary flap(s) from its/their proximal region(s) 766, 770, thereby facilitating the access to the detergent product. This may be rendered possible preferably by tearing-off the secondary precut line(s) 756, 762. The result of this method is shown in FIG. 15B, showing the distal regions 768, 772 of the secondary flaps attached below the lower flap 718 and the proximal regions 766, 770 of the secondary flaps remaining connected to the sidewalls 112, 114.

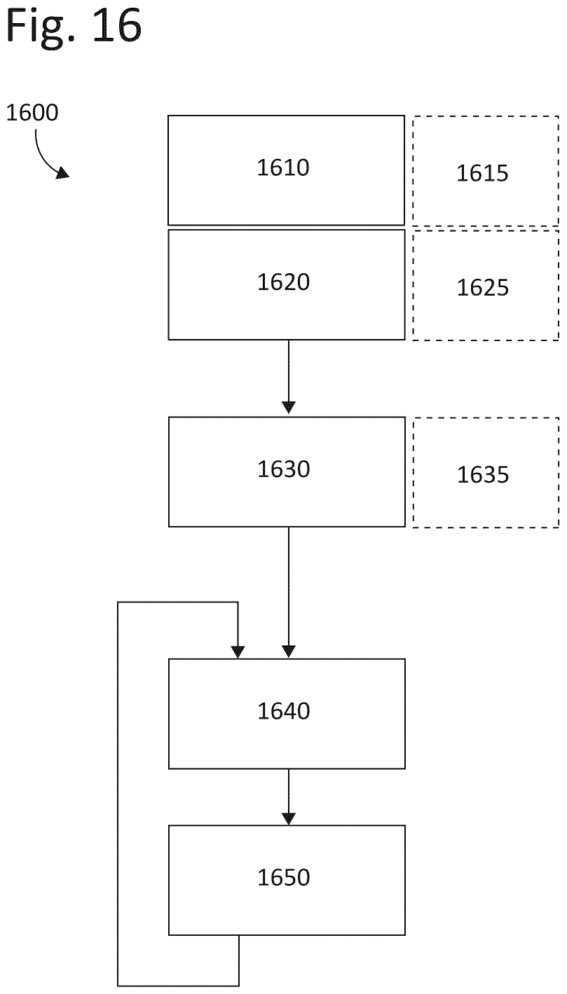

FIG. 16 is a diagram showing the various steps that can be carried out in a sixth example method. It should be noted that FIGS. 1A to 15B show various aspects of the consumer product, each of these aspects being seen as optional. Similarly, one should note that each step presented in FIG. 16 is optional.

The method 1600 may comprise a first step 1610 of pulling the tab 124/224. Simultaneously to pulling the tab, a step of tearing off 1615 precut lines 230, 232 may happen, thereby separating the proximal region of the upper flap from the distal region of the upper flap.

While pulling 1620 the tab 124/224 further, the cutout handle 642 is formed by detaching 1625 the handle portion 536 from the lower flap.

Once the upper flap is fully folded open, one can open 1630 the lower flap. Opening the lower flap may be performed by pulling upwards the lower flap after inserting one or more fingers in the optional precut handle 642. Simultaneously, the secondary flaps 750, 752 may be teared off 1635: their distal region remaining attached to the lower flap while their proximal region remains connected to the sidewalls 112, 114.

Once these steps have been carried out, the end user has access to the detergent product. The end user may then close 1640 the container by pressing down the upper flap over the lower flap and pushing down the upper flap such that the tab engages the tab receptor. Once closed, the container may be open again 1650, for instance by pushing the lower flap down. The closed loop arrow illustrates that closing and opening by engaging or releasing the tab from the tab receptor can be done repeatedly.

In some examples, the consumer product may comprise, optionally drawn on an outer surface of the container, instructions indicating how to operate the tab/tab receptor to open and close the container and/or indicating how to tear off the various precut lines of the container in its initial configuration.

### Material Constituting the Container

As detailed below, the container of this disclosure can be partially or totally made from a paper material such as a material selected from paperboard, cardboard, laminates comprising at least one paper board or cardboard layer. Paperboard or cardboard comprise cellulose fibre materials or a mixture thereof. The material used to make the container may comprise other ingredients, such as colorants, protective varnishes, surface enhancement coatings, barrier coatings, preservatives, recycled fibre materials, plasticisers, UV stabilizers, oxygen barriers, perfume barriers, and moisture barriers, or a mixture thereof. In some examples, in order to provide a desired tear resistance and strength, cellulose fibres length is in a range from 0.1 to 5 mm, preferably from 1 to 3 mm. In some examples, cellulose fibres are sourced from various sources such as virgin soft or hard woods, hemp, grass, corn, bagasse, sugarcane, bamboo and others, and/or from post producer or post-consumer recycled paper and cardboard. The container may comprise areas of external or internal printing. The container may be made for example by cardboard making. Suitable container manufacturing processes may include, but are not limited to, tube forming from a flat cardboard or paperboard sheet with a gluing step, folding, or a mixture thereof. The container may be opaque or may filter some specific wavelengths, for example to protect content from external light. In some examples the container is constructed at least in part and in some specific examples in its entirety from paper-based material. By paper-based material, we herein mean a material comprising paper. Without being bound by theory, ‘paper’ is to be understood as a material made from a cellulose-based pulp. Paperboard may be made from a paper-based material having a thickness and rigidity such that it does not collapse under its own weight. While paperboard should be understood as comprising a single layer of material, cardboard should be understood as comprising a plurality of paper-based material layers. In some examples, the paper-based material comprises paperboard, cardboard, or a mixture thereof, wherein preferably, cardboard comprises paperboard, corrugated fibre-board, or a mixture thereof. Corrugated fiber-board comprises a series of flutes. Each flute can be understood to be a channel. The flutes run parallel to one another, with the flute direction being the direction travelled along each channel.

Further details of the material forming the container are given further below.

The paper-based material may be a laminate comprising paper, cardboard, or a mixture thereof, wherein in some examples, cardboard comprises paperboard, corrugated fiber-board, or a mixture thereof, and in some examples at least another material. In some examples, the at least another material comprises a plastic material. In some examples, the plastic material comprises polyethylene, more specifically Low-Density PolyEthylene (LDPE), polyethylene terephthalate, polypropylene, polyvinylalcohol or a mixture thereof. In some examples the plastic material comprises a copolymer from an ethylene starting monomer and vinyl alcohol, or EVOH. A barrier material may be used as the at least another material. The barrier material may be a biaxially orientated polypropylene, a metallised polyethylene terephthalate, or a mixture thereof. The at least another material may comprise a wax, a cellulose material, polyvinylalcohol, silica dioxide, cascin-based materials, or a mixture thereof. In some examples, the paper-based laminate comprises more than 50%, preferably more than 85%, and more preferably more than 95% by weight of the paper-based laminate of fiber-based materials. In some examples, the barrier material may comprise plastic material having a thickness of between 10 micron and 60 microns. In some examples, the barrier material may comprise plastic material having a thickness of between 10 micron and 35 microns. The paper-based material may be a laminate.

In some examples, the internal surface of a container comprises paperboard, cardboard, or a mixture thereof, wherein, in specific examples, cardboard comprises paperboard, corrugated fiber-board and lamination of polyethylene, especially LDPE, or a mixture thereof, and, in some examples, the external surface of the container comprises the at least another material. Alternatively, the at least another material might also be laminated in-between two paper-based material layers such as the paperboard or cardboard layers as per this disclosure. Without wishing to be bound by theory this at least another material might act as a barrier for leaked liquid absorbed by the paper-based material facing the inner side of the container, to prevent or reduce a contaminating flow through a wall of the container. Other structures may be found efficient to avoid leakage from the content or to protect the content from external fluids, for example from a shower, a sink, or by handling the container with wet hands. Contamination of a wall of the container might be unsightly to consumers or may contaminate the storage area.

In some examples, the container is made of a paper-based material comprising the at least another material laminated in between two corrugated fiberboard layers.

In some examples, the material used for the container comprises a core cardboard flute material sandwiched between two plain cardboard (or paperboard) layers and polyethylene laminate.

A paperboard or cardboard layer according to this disclosure may be made from or may comprise recycled material or recycled cellulose fibres. The external surface of the container may comprise a coating or a varnish. Such a coating or varnish can help making a board repellent to water or help protecting a content such as an enclosed detergent composition from UV light. The coating or varnish could also help protecting the external surface of the lid, box or container from being contaminated by the content, for example an enclosed detergent composition, for example if leakage of a water-soluble unit dose detergent enclosing a liquid detergent composition would occur.

A coating or vanish on the internal surface can help to prevent the content to stick to the inner surface or prevent migration of inks, colorants, perfumes, non-ionics, oils, greases and other ingredients from the content into the board or inks or additives from the board onto the content. In some examples detergent resistant varnishes or coatings can be applied on areas exposed to the contents.

As noted above, the container may indeed be made from paper or cardboard material, in particular rigid cardboard material, flexible cardboard material or a mixture thereof. In some examples, the material forming the container or the cover has a wall thickness of more than 220 microns and of less than 3 mm. In some examples, the material forming the container has a thickness of more than Imm and of less than 2 mm. In some examples, the material forming the container is folded on itself, for example to reinforce parts of or the whole of the box or the cover. The container may be made from paper materials, bio-based material, bamboo fibres, cellulose fibres, cellulose based or fibre-based materials, or a mixture thereof. The container may be made from materials comprising recycled materials, for example recycled cellulose fibre-based materials. In some examples, in order to facilitate opening, the cover may be entirely separated from the box when open, and the cover weighs less than 200 g, preferably less than 100 g, even more preferably less than 80 g, and more than 10 g, more preferably more than 30 g, even more preferably more than 40 g, in order to obtain a sufficiently robust cover structure.

In some examples, the container is made of a corrugated cardboard layer, the corrugated cardboard layer comprising flutes, the flutes preferably running parallel to a vertical direction (for the sidewalls, and a respective corresponding direction for the flaps of the cover and the base). The flutes reinforce the strength of the container.

### Laundry Detergent Composition

In some examples the detergent product comprises a detergent composition. The detergent composition may be a laundry detergent composition, an automatic dishwashing composition, a hard surface cleaning composition, or a combination thereof. The detergent composition may comprise a solid, a liquid or a mixture thereof. The term liquid includes a gel, a solution, a dispersion, a paste, or a mixture thereof. The solid may be a powder. By powder we herein mean that the detergent composition may comprise solid particulates or may be a single homogenous solid. In some examples, the powder detergent composition comprises particles. This means that the powder detergent composition comprises individual solid particles as opposed to the solid being a single homogenous solid. The particles may be free-flowing or may be compacted. A laundry detergent composition can be used in a fabric hand wash operation or may be used in an automatic machine fabric wash operation, for example in an automatic machine fabric wash operation.

The laundry detergent composition may comprise the solid linear alkyl benzene sulphonate anionic detersive surfactant particle.

Typically, the laundry detergent composition is a fully formulated laundry detergent composition, not a portion thereof such as a spray-dried, extruded or agglomerate particle that only forms part of the laundry detergent composition. Typically, the solid composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellac particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry detergent compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hucing agents; dye transfer inhibitors; dye fixative agents; perfume; silicone; fabric softening agents, such as clay; flocculants, such as polyethyleneoxide; suds suppressors; and any combination thereof.

Suitable laundry detergent compositions may have a low buffering capacity. Such laundry detergent compositions typically have a reserve alkalinity to pH 9.5 of less than 5.0gNaOH/100 g. These low buffered laundry detergent compositions typically comprise low levels of carbonate salt.

Detersive Surfactant: Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial.

Anionic detersive surfactant: Suitable anionic detersive surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

Non-ionic detersive surfactant: Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable non-ionic detersive surfactants include secondary alcohol-based detersive surfactants.

Cationic detersive surfactant: Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.
Zwitterionic detersive surfactant: Suitable zwitterionic detersive surfactants include amine oxides and/or betaines.
Polymer: Suitable polymers include carboxylate polymers, soil release polymers, anti-redeposition polymers, cellulosic polymers, care polymers and any combination thereof.
Carboxylate polymer: The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II): formula (I):

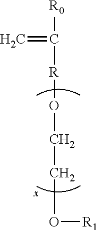

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;
formula (II)

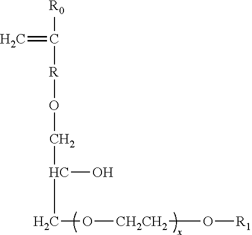

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

It may be preferred that the polymer has a weight average molecular weight of at least 50 kDa, or even at least 70 kDa.

Soil release polymer: The composition may comprise a soil release polymer. A suitable soil release polymer has a structure as defined by one of the following structures (I), (II) or (III):

—[(OCHR¹—CHR²)ₙ—O—OC—Ar—CO—]_{d} (I)

—[(OCHR³—CHR⁴)_{b}—O—OC—sAr—CO—]ₑ (II)

—[(OCHR⁵—CHR⁶)_{c}—OR⁷]_{f} (III)

wherein: a, b and c are from 1 to 200; d, e and f are from 1 to 50; Ar is a 1,4-substituted phenylene; sAr is 1,3-substituted phenylene substituted in position 5 with SO₃Me; Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof; R₁, R₂, R₃, R⁴, R⁵ and R⁶ are independently selected from H or C₁-C₁₈ n—or iso-alkyl; and R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are sold by Clariant under the TexCare® series of polymers, e.g., TexCare® SRN240 and TexCare® SRA300. Other suitable soil release polymers are sold by Solvay under the Repel-o-Tex® series of polymers, e.g., Repel-o-Tex® SF2 and Repel-o-Tex® Crystal.

Anti-redeposition polymer: Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide unit can be less than 0.02, or less than 0.016, the average number of graft sites per ethylene oxide unit can be in the range of from 0.010 to 0.018, or the average number of graft sites per ethylene oxide unit can be less than 0.010, or in the range of from 0.004 to 0.008.

Suitable polyethylene glycol polymers are described in WO 08/007320 A1.

A suitable polyethylene glycol polymer is Sokalan HP22.

Cellulosic polymer: Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof.

Suitable carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g., as described in WO 09/154933 A1.

Care polymers: Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

Bleach: Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Source of hydrogen peroxide: Suitable sources of hydrogen peroxide include sodium perborate and/or sodium percarbonate.

Bleach activator: Suitable bleach activators include tetra acetyl ethylene diamine and/or

alkyl oxybenzene sulphonate.

Bleach catalyst: The composition may comprise a bleach catalyst. Suitable bleach catalysts include oxaziridinium bleach catalysts, transition metal bleach catalysts, especially manganese and iron bleach catalysts. A suitable bleach catalyst has a structure corresponding to general formula below:

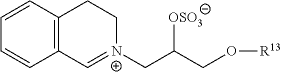

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

Pre-formed peracid: Suitable pre-form peracids include phthalimido-peroxycaproic acid.

Enzymes: Suitable enzymes include lipases, proteases, cellulases, amylases and any combination thereof.

Protease: Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz PR series of proteases including Preferenz® P280, Preferenz® P281, Preferenz® P2018-C, Preferenz® P2081-WE, Preferenz® P2082-EE and Preferenz® P2083-A/J, Properasc®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V1041+G159S, hereinafter referred to as BLAP), BLAP R (BLAP with S3T+V41+V199M+V2051+L217D), BLAP X (BLAP with S3T+V41+V2051) and BLAP F49 (BLAP with S3T+V41+A194P+V199M+V2051+L217D)−all from Henkel/Kemira; and KAP (Bacillus alkalophilus subtilisin with mutations A230V+S256G+S259N) from Kao.

A suitable protease is described in WO 11/140316 A1 and WO 11/072117 A1.

Amylase: Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

A suitable amylase is described in WO 06/002643 A1.

Cellulase: Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic. Suitable cellulases are described in WO 07/144857 A1 and WO 10/056652 A1.

Lipase: Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g., such as those described in WO 06/090335 A1 and WO 13/116261 A1. In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark.

Other suitable lipases include: Liprl 139, e.g., as described in WO 2013/171241 A1; and TfuLip2, e.g., as described in WO 2011/084412 A1 and WO 2013/033318 A1.

Other enzymes: Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™.

Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

Zeolite builder: The composition may comprise zeolite builder. The composition may comprise from 0 wt % to 5 wt % zeolite builder, or 3 wt % zeolite builder. The composition may even be substantially free of zeolite builder; substantially free means “no deliberately added”. Typical zeolite builders include zeolite A, zeolite P and zeolite MAP.

Phosphate builder: The composition may comprise phosphate builder. The composition may comprise from 0 wt % to 5 wt % phosphate builder, or to 3 wt %, phosphate builder. The composition may even be substantially free of phosphate builder; substantially free means “no deliberately added”. A typical phosphate builder is sodium tri-polyphosphate.

Carbonate salt: The composition may comprise carbonate salt. The composition may comprise from 0 wt % to 10 wt % carbonate salt, or to 5 wt % carbonate salt. The composition may even be substantially free of carbonate salt; substantially free means “no deliberately added”. Suitable carbonate salts include sodium carbonate and sodium bicarbonate.

Silicate salt: The composition may comprise silicate salt. The composition may comprise from 0 wt % to 10 wt % silicate salt, or to 5 wt % silicate salt. A preferred silicate salt is sodium silicate, especially preferred are sodium silicates having a Na₂O: SiO₂ ratio of from 1.0 to 2.8, preferably from 1.6 to 2.0.

Sulphate salt: A suitable sulphate salt is sodium sulphate.

Brightener: Suitable fluorescent brighteners include: di-styryl biphenyl compounds, e.g., Tinopal® CBS-X, di-amino stilbene di-sulfonic acid compounds, e.g., Tinopal® DMS pure Xtra and Blankophor® HRH, and Pyrazoline compounds, e.g., Blankophor® SN, and coumarin compounds, e.g., Tinopal® SWN.

Preferred brighteners are: sodium 2 (4-styryl-3-sulfophenyl)-2H-napthol [1,2-d] triazole, disodium 4,4′-bis {[(4-anilino-6-(N methyl-N-2 hydroxyethyl)amino 1,3,5-triazin-2-yl)];amino} stilbene-2-2′ disulfonate, disodium 4,4′-bis {[(4-anilino-6-morpholino-1,3,5-triazin-2-yl)]amino} stilbene-2-2′ disulfonate, and disodium 4,4′-bis(2-sulfostyryl) biphenyl. A suitable fluorescent brightener is C.I. Fluorescent Brightener 260, which may be used in its beta or alpha crystalline forms, or a mixture of these forms.

Chelant: The composition may also comprise a chelant selected from: diethylene triamine pentaacetate, diethylene triamine penta (methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′-disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

Hueing agent: Suitable hucing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hucing agents include Acid Violet 50, Direct Violet 9, 66 and 99, Solvent Violet 13 and any combination thereof.

Many hucing agents are known and described in the art which may be suitable for the present invention, such as hucing agents described in WO 2014/089386 A1.

Suitable hueing agents include phthalocyanine and azo dye conjugates, such as described in WO 2009/069077 A1.

Suitable hucing agents may be alkoxylated. Such alkoxylated compounds may be produced by organic synthesis that may produce a mixture of molecules having different degrees of alkoxylation. Such mixtures may be used directly to provide the hucing agent or may undergo a purification step to increase the proportion of the target molecule. Suitable hucing agents include alkoxylated bis-azo dyes, such as described in WO 2012/054835 A1, and/or alkoxylated thiophenc azo dyes, such as described in WO 2008/087497 A1 and WO2012/166768 A1.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hucing agents can be incorporated into hucing dye particles, such as described in WO 2009/069077 A1.

Dye transfer inhibitors: Suitable dye transfer inhibitors include polyamine N-oxide polymers, copolymers of N-vinylpyrrolidone and N-vinylimidazole, polyvinylpyrrolidonc, polyvinyloxazolidonc, polyvinylimidazole and mixtures thereof. Preferred are poly(vinyl pyrrolidone), poly(vinylpyridine betaine), poly(vinylpyridine N-oxide), poly(vinyl pyrrolidonc-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

Perfume: Suitable perfumes comprise perfume materials selected from the group: (a) perfume materials having a ClogP of less than 3.0 and a boiling point of less than 250° C. (quadrant 1 perfume materials); (b) perfume materials having a ClogP of less than 3.0 and a boiling point of 250° C. or greater (quadrant 2 perfume materials); (c) perfume materials having a ClogP of 3.0 or greater and a boiling point of less than 250° C. (quadrant 3 perfume materials); (d) perfume materials having a ClogP of 3.0 or greater and a boiling point of 250° C. or greater (quadrant 4 perfume materials); and (c) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof. A suitable perfume microcapsule is described in WO 2009/101593 A1.

Silicone: Suitable silicones include polydimethylsiloxane and amino-silicones. Suitable silicones are described in WO 05075616 A1.

Process for making the solid composition: Typically, the particles of the composition can be prepared by any suitable method. For example: spray-drying, agglomeration, extrusion and any combination thereof.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower, such as described in WO 2009/158162 A1.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump, such as described in WO 09/158449 A1.

It may be preferred for a gas, such as air, to be introduced into the spray-drying process after the step of forming the aqueous slurry, such as described in WO 2013/181205 A1.

It may be preferred for any inorganic ingredients, such as sodium sulphate and sodium carbonate, if present in the aqueous slurry mixture, to be micronized to a small particle size such as described in WO 2012/134969 A1.

Typically, a suitable agglomeration process comprises the step of contacting a detersive ingredient, such as a detersive surfactant, e.g., linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process.

Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10 wt % of the agglomerates have a particle size less than 150 micrometers and less than 10 wt % of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

Method of laundering fabric: The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2 g/l to 20 g/l, or from 0.5 g/l to 10 g/l, or to 5.0 g/l. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200 g or less, or 150 g or less, or 100 g or less, or 50 g or less of laundry detergent composition is contacted to water to form the wash liquor.

### Water-Soluble Unit Dose Article

The detergent may be in the form of water-soluble unit doses articles comprising a water-soluble fibrous non-woven sheet and a granular laundry detergent composition. The fibrous non-woven sheet is described in more detail below and the granular laundry detergent composition is described in more detail above as according to the present invention.

The water-soluble fibrous non-woven sheet is shaped to form a sealed internal compartment, wherein the granular laundry detergent composition is comprised within said internal compartment.

The unit dose article may comprise a first fibrous non-woven sheet and a second water-soluble fibrous non-woven sheet sealed to one another such to define the internal compartment.

The water-soluble unit dose article is constructed such that the granular detergent composition does not leak out of the compartment during storage. However, upon addition of the water-soluble unit dose article to water, the water-soluble non-woven fibrous sheet dissolves and releases the contents of the internal compartment into the wash liquor.

The compartment should be understood as meaning a closed internal space within the unit dose article, which holds the granular detergent composition. During manufacture, a first water-soluble fibrous non-woven sheet may be shaped to comprise an open compartment into which the detergent composition is added. A second water-soluble fibrous non-woven sheet may then be laid over the first sheet in such an orientation as to close the opening of the compartment. The first and second sheets are then sealed together along a seal region.

Alternatively, a single water-soluble fibrous non-woven may be shaped into an open container. The granular laundry detergent composition may then be filled into the open container and then the open container sealed to close it.

The unit dose article may comprise more than one compartment, at least two compartments, or even at least three compartments. The compartments may be positioned in a side-by-side orientation, i.e., one orientated next to the other. Alternatively, one compartment may be completely enclosed within another compartment.

When the unit dose article comprises at least two compartments, one of the compartments may be smaller than the other compartment.

Each compartment may comprise the same or different compositions.

### Water-soluble Fibrous Non-woven Sheet

The water-soluble unit dose article may comprise a water-soluble fibrous non-woven sheet. The water-soluble fibrous non-woven sheet comprises a plurality of fibres. Preferably, the fibres are inter-entangled fibres in the form of a fibrous structure.

The water-soluble fibrous non-woven sheet may be homogeneous or may be layered. If layered, the water-soluble fibrous non-woven sheet may comprise at least two and/or at least three and/or at least four and/or at least five layers.

Preferably, the water-soluble fibrous non-woven sheet has a basis weight of between 20 gsm and 60 gsm, preferably between 20 gsm and 55 gsm, more preferably between 25 gsm and 50 gsm, most preferably between 25 gsm and 45 gsm. Those skilled in the art will be aware of methods to measure the basis weight.

The water-soluble fibrous non-woven sheet may have a thickness between 0.01 mm and 100 mm, preferably between 0.05 mm and 50 mm, more preferably between 0.1 mm and 20 mm, even more preferably between 0.1 mm and 10 mm, even more preferably between 0.1 mm and 5 mm, even more preferably between 0.1 mm and 2 mm, even more preferably between 0.1 mm and 0.5 mm, most preferably between 0.1 mm and 0.3 mm. Those skilled in the art will be aware of standard methods to measure the thickness.

The fibres comprise polyvinyl alcohol polymer. Preferably, the fibres comprise between 50% and 98%, preferably between 65% and 97%, more preferably between 80% and 96%, even more preferably between 88% and 96% by weight of the fibre of polyvinyl alcohol.

The polyvinyl alcohol polymer may have a weight average molecular weight of between 50 kDa and 150 kDa, preferably between 75 kDa and 140 kDa, more preferably between 100 kDa and 130 kDa. “Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121. Those skilled in the art will be aware of other known techniques to determine the weight average molecular weight (MW).

Preferably, the polyvinyl alcohol polymer is a polyvinyl alcohol homopolymer. Preferably, the polyvinyl alcohol homopolymer has an average percentage degree of hydrolysis of from 75% to 100%, preferably of from 80% to 95%, most preferably of from 85% to 90%. Preferably, the polyvinyl alcohol homopolymer has an average viscosity of from 1 to 30 mPas, preferably from 5 to 25mPas, most preferably from 10 to 20 mPas, wherein the viscosity is measured as a 4% aqueous solution in demineralized water at 20° C.

In some examples the container may comprise between 1 and 80 water-soluble unit dose articles, between 1 and 60 water-soluble unit dose articles, between 1 and 40 water-soluble unit dose articles, or between 1 and 20 water-soluble unit dose articles. The capacity of the container may be comprised between 500 ml and 5000 ml, in some examples between 800 ml and 4000 ml.

### Examples of the Consumer Product of the Present Disclosure

In a 1^{st} aspect, a consumer product comprises a container and a detergent product contained therein, preferably the detergent product as described herein, the container comprising: a base; a plurality of sidewalls among which a first sidewall and a second sidewall opposite the first sidewall, the first and the second sidewalls having a respective top edge, the detergent product lying in direct contact with the plurality of sidewalls; and a cover comprising: a lower flap connected to the top edge of the first sidewall; and an upper flap connected to the top edge of the second sidewall, wherein the upper flap comprises: two lateral edges; a through-opening; and two main precut lines connecting the through-opening to a respective one of the two lateral edges, an optional tab protruding at the through-opening and connecting the two main precut lines together, wherein the through-opening and the two main precut lines divide the upper flap into a proximal region and a distal region, wherein the distal region of the upper flap is attached to the lower flap. In some examples of such aspect and of the following aspects, the upper flap is free of tab and/or the lower flap is free of tab receptor. In some examples of such aspect and of the following aspects, the direct contact between the detergent product and the sidewalls is optional.

In a 2^{nd} aspect, to be considered independently from the 1^{st} aspect or in combination with the 1^{st} aspect, a consumer product comprises a container and a detergent product contained therein, preferably the detergent product as described herein, the container comprising: a base; a plurality of sidewalls among which a first sidewall and a second sidewall opposite the first sidewall, the first and the second sidewalls having a respective top edge, the detergent product lying in direct contact with the plurality of sidewalls; and a cover comprising: a lower flap connected to the top edge of the first sidewall; and an upper flap connected to the top edge of the second sidewall; wherein a proximal region of the upper flap has two lateral edges and two teared-off edges connecting an optional tab to a respective one of the lateral edges, and wherein a distal region of the upper flap is arranged over the lower flap and attached thereto, wherein the distal region of the upper flap has two teared-off edges respectively mirroring the teared-off edges of the proximal region of the upper flap.

In a 3^{rd} aspect, to be considered independently from the previous aspects or to be considered in combination with any of the previous aspects, a consumer product comprises a container and a detergent product contained therein, preferably the detergent product as described herein, the container comprising: a base; a plurality of sidewalls among which a first sidewall and a second sidewall opposite the first sidewall, the first and the second sidewalls having a respective top edge, the detergent product lying in direct contact with the plurality of sidewalls; and a cover comprising: a lower flap connected to the top edge of the first sidewall; and an upper flap connected to the top edge of the second sidewall; wherein the lower flap and the upper flap are attached together in a handle region of the lower flap delimited by a handle precut line, the handle region being optionally adjacent to a distal edge of the lower flap.

In a 4th aspect, to be considered independently from the previous aspects or to be considered in combination with any of the previous aspects, a consumer product comprises a container and a detergent product contained therein, preferably the detergent product as described herein, the container comprising: a base; a plurality of sidewalls among which a first sidewall and a second sidewall opposite the first sidewall, the first and the second sidewalls having a respective top edge, the detergent product lying in direct contact with the plurality of sidewalls; and a cover comprising: a lower flap connected to the top edge of the first sidewall; and an upper flap connected to the top edge of the second sidewall; wherein the lower flap comprises a cutout handle having a shape, and wherein a handle region of the lower flap is attached below the upper flap, wherein the handle region has a shape that is complementary to the shape of the cutout handle.

In a 5th aspect, to be considered independently from the previous aspects or to be considered in combination with any of the previous aspects, a consumer product comprises a container and a detergent product contained therein, preferably the detergent product as described herein, the container comprising: a base; a plurality of sidewalls among which a first sidewall and a second sidewall opposite the first sidewall, the first and the second sidewalls having a respective top edge, the detergent product lying in direct contact with the plurality of sidewalls; and a cover comprising: a lower flap connected to the top edge of the first sidewall; an upper flap connected to the top edge of the second sidewall; a first secondary flap covered by the lower flap, the first secondary flap comprising: a first proximal edge where the first secondary flap connects to a third sidewall of the plurality of sidewalls, the third sidewall being different from the first and second sidewalls; a first distal edge; a first secondary precut line between the first proximal edge and the first distal edge; a first proximal region delimited by the first proximal edge and by the first secondary precut line; and a first distal region delimited by the first distal edge and by the first secondary precut line; a first attachment element between the lower flap and the first secondary flap, the first attachment element extending within the first distal region, the first proximal region being substantially free of attachment element; a second secondary flap covered by the lower flap, the second secondary flap comprising: a second proximal edge where the second secondary flap connects to a fourth sidewall of the plurality of sidewalls, the fourth sidewall being different from the first, second and third sidewalls; a second distal edge; a second secondary precut line between the second proximal edge and the second distal edge; a second proximal region delimited by the second proximal edge and by the second secondary precut line; and a second distal region delimited by the second distal edge and by the second secondary precut line; and a second attachment element between the lower flap and the second secondary flap, the second attachment element extending within the second distal region, the second proximal region being substantially free of attachment element.

In 6^{th} aspect in accordance with the 3^{rd} and the 5^{th} aspects and potentially in combination with any other aspects, the first and second secondary flaps extend below the lower flap over respective regions of the lower flap that do not overlap the handle region.

In a 7^{th} aspect, to be considered independently from the previous aspects or to be considered in combination with any of the previous aspects, a consumer product comprises a container and a detergent product contained therein, preferably the detergent product as described herein, the container comprising: a base; a plurality of sidewalls among which a first sidewall and a second sidewall opposite the first sidewall, the first and the second sidewalls having a respective top edge, the detergent product lying in direct contact with the plurality of sidewalls; and a cover comprising: a lower flap connected to the top edge of the first sidewall; and an upper flap connected to the top edge of the second sidewall, wherein a proximal region of a secondary flap is connected to a third sidewall of the plurality of sidewalls, the third sidewall being different from the first and second sidewalls, wherein the proximal region comprises a teared-off edge; and wherein a distal region of the secondary flap is attached below the lower flap and has a teared-off edge mirroring the teared-off edge of the proximal region of the secondary flap.

In an 8^{th} aspect, to be considered independently from the previous aspects or to be considered in combination with any of the previous aspects, a consumer product comprises a container and a detergent product contained therein, preferably the detergent product as described herein, the container comprising: a base; a plurality of sidewalls among which a first sidewall and a second sidewall opposite the first sidewall, the first and the second sidewalls having a respective top edge, the detergent product lying in direct contact with the plurality of sidewalls; and a cover comprising: a lower flap connected to the top edge of the first sidewall; and an upper flap connected to the top edge of the second sidewall, wherein a tab has a curved convex distal edge, and wherein a tab receptor comprises a curved slit formed in the lower flap, the curved slit separating a convex edge of the lower flap from a concave edge of the lower flap, wherein the concave edge lies below the tab and the convex edge of the lower flap lies above the tab as the tab is engaged in the slit.

In a 9^{th} aspect, combinable with any of the previous aspects, the container is made of a corrugated material comprising flutes oriented along a longitudinal direction and the top edges are perpendicular to the longitudinal direction.

In a 10^{th} aspect, a method of operating the consumer product of the 1^{st} aspect potentially in combination with any other aspects, the method comprising opening the upper flap and simultaneously tearing the distal region of the upper flap from the proximal region of the upper flap.

In an 11^{th} aspect, a method of operating the consumer product of the 3^{rd} aspect potentially in combination with any other aspects, the method comprising opening the upper flap and simultaneously tearing the handle region from the lower flap to form the handle.

In an 12^{th} aspect, a method of operating the consumer product of the 5^{th} aspect potentially in combination with any other aspects, comprising opening the lower flap and simultaneously tearing the first and second distal regions from the first and second proximal regions of the first and second secondary flaps, the first and second distal regions remaining attached to the lower flap and the first and second proximal regions remaining connected to the third and fourth sidewalls.

In a 13^{th} aspect, a method according to aspects 10 to 12 is carried out with a container made of a corrugated material comprising flutes oriented along a longitudinal direction, and the steps of opening the upper flap and/or opening the lower flap consist in pivoting the upper/lower flap(s) around an axis that is perpendicular to the longitudinal direction.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer product comprising a container and a detergent product contained therein, the container comprising:
a base;
a plurality of sidewalls among which a first sidewall and a second sidewall opposite the first sidewall, the first and the second sidewalls having a respective top edge, the detergent product lying in direct contact with the plurality of sidewalls; and
a cover comprising:
a lower flap connected to the top edge of the first sidewall, the lower flap being provided with a tab receptor; and
an upper flap connected to the top edge of the second sidewall, the upper flap comprising a tab repeatably engageable into, and repeatably releasable from, the tab receptor.

2. The consumer product of claim 1, wherein the upper flap further comprises:
two lateral edges;
a through-opening; and
two main precut lines connecting the through-opening to a respective one of the two lateral edges, the tab protruding at the through-opening and connecting the two main precut lines (together,
wherein the through-opening and the two main precut lines divide the upper flap into a proximal region and a distal region, wherein the distal region of the upper flap is attached to the lower flap, and wherein the tab pertains to the proximal region.

3. The consumer product of claim 1, wherein a proximal region of the upper flap has two lateral edges and two teared-off edges connecting the tab to a respective one of the lateral edges, and wherein a distal region of the upper flap is arranged over the lower flap and attached thereto, wherein the distal region of the upper flap has two teared-off edges respectively mirroring the teared-off edges of the proximal region of the upper flap.

4. The consumer product of claim 1, wherein the lower flap and the upper flap are attached together in a handle region of the lower flap delimited by a handle precut line.

5. The consumer product of claim 4, wherein the handle region is adjacent to a distal edge of the lower flap.

6. The consumer product of claim 1, wherein the lower flap comprises a cutout handle having a shape, and wherein a handle region of the lower flap is attached below the upper flap, wherein the handle region has a shape that is complementary to the shape of the cutout handle.

7. The consumer product of claim 1, wherein the cover further comprises:
a first secondary flap covered by the lower flap, the first secondary flap comprising:
a first proximal edge where the first secondary flap connects to a third sidewall of the plurality of sidewalls, the third sidewall being different from the first and second sidewalls;
a first distal edge;
a first secondary precut line between the first proximal edge and the first distal edge;
a first proximal region delimited by the first proximal edge and by the first secondary precut line; and
a first distal region delimited by the first distal edge and by the first secondary precut line;
a first attachment element between the lower flap and the first secondary flap, the first attachment element extending within the first distal region, the first proximal region being substantially free of attachment element;
a second secondary flap covered by the lower flap, the second secondary flap comprising:
a second proximal edge where the second secondary flap connects to a fourth sidewall of the plurality of sidewalls, the fourth sidewall being different from the first, second and third sidewalls;
a second distal edge;
a second secondary precut line between the second proximal edge and the second distal edge;
a second proximal region delimited by the second proximal edge and by the second secondary precut line; and
a second distal region delimited by the second distal edge and by the second secondary precut line; and
a second attachment element between the lower flap and the second secondary flap, the second attachment element extending within the second distal region, the second proximal region being substantially free of attachment element.

8. The consumer product of claim 7, wherein the first and second secondary flaps extend below the lower flap over respective regions of the lower flap that do not overlap the handle region.

9. The consumer product of claim 7,
wherein a proximal region of a secondary flap is connected to a third sidewall of the plurality of sidewalls, the third sidewall being different from the first and second sidewalls, wherein the proximal region comprises a teared-off edge; and
wherein a distal region of the secondary flap is attached below the lower flap and has a teared-off edge mirroring the teared-off edge of the proximal region of the secondary flap.

10. The consumer product according to claim 1, wherein the tab has a curved convex distal edge, and wherein the tab receptor comprises a curved slit formed in the lower flap, the curved slit separating a convex edge of the lower flap from a concave edge of the lower flap, wherein the concave edge lies below the tab and the convex edge of the lower flap lies above the tab as the tab is engaged in the slit.

11. A method of operating the consumer product of claim 1, comprising closing the container by pushing down the upper flap until the tab engages the tab receptor so as to prevent access to the detergent product.

12. A method of operating the consumer product of claim 1, comprising opening the container by pushing down the lower flap to release the tab from the tab receptor so as to access the detergent product.

13. A method of operating the consumer product of claim 2, comprising pulling the tab and simultaneously tearing the distal region of the upper flap from the proximal region of the upper flap.

14. A method of operating the consumer product of claim 5, comprising pulling the tab and simultaneously tearing the handle region from the lower flap to form the handle.

15. A method of operating the consumer product of claim 8, comprising pulling the cut-out handle of the lower flap and simultaneously tearing the first and second distal regions from the first and second proximal regions of the first and second secondary flaps, the first and second distal regions remaining attached to the lower flap and the first and second proximal regions remaining connected to the third and fourth sidewalls.
